(19) United States
(12) Patent Application Publication
(10) Pub. No.: US 2015/0248974 A1
(43) Pub. Date: Sep. 3, 2015

(54) MULTI-PRINT FILM AND MULTI-LIGHT SWITCH FOR VEHICLE USING THE SAME

(71) Applicant: ALPS ELECTRIC KOREA CO., LTD., Gwangju (KR)

(72) Inventors: Hoosang LEE, Gwangju (KR); Daeyeon YANG, Gwangju (KR); Byung Suk BANG, Gwangju (KR)

(21) Appl. No.: 14/633,356

(22) Filed: Feb. 27, 2015

(30) Foreign Application Priority Data
Feb. 28, 2014 (KR) 10-2014-0024338

(51) Int. Cl. H01H 9/16; B60Q 3/04; F21V 9/08

(52) U.S. Cl. CPC H01H 9/161; F21V 9/08; B60Q 3/044; F21W 2101/08

(57) ABSTRACT

A multi-print film having a multi-layer structure in which a first recognition mark and a second recognition mark are separately displayed. The multi-print film may include a first printed layer on which the first recognition mark configured to transmit the wavelength of a first light source, but to not transmit the wavelength of a second light source is printed and a second printed layer on which the second recognition mark configured to transmit the wavelength of the second light source, but to not transmit the wavelength of the first light source is printed.

### CROSS REFERENCE TO RELATED APPLICATION

This application claims priority to Korean Patent Application No 10-2014-0024338, filed on Feb. 28, 2014, the contents of which are incorporated herein in their entirety.

### BACKGROUND OF THE INVENTION

1. Technical Field

The present invention relates to a printed film and a light switch for a vehicle and, more particularly, to a multi-print film and a multi-light switch for a vehicle using the same.

2. Description of the Related Art

FIG. 1 is a perspective view of a conventional light switch for a vehicle, and FIG. 2 is a cross-sectional view of the conventional light switch for a vehicle. Referring to FIG. 1 and FIG. 2, in a prior art, when a user actuates a switch knob 10, light is supplied by a light source 40 and passes through a recognition mark 30, so the user may recognize the recognition mark 30.

That is, when a user presses the switch knob 10, a contact point 50 switches and the light source 40 projects light on an indicator 20 and the recognition mark 30. Furthermore, when the switch knob 10 is pressed once more, the light is turned off, thus becoming an off state.

As described above, in a prior art, only one mode is inevitably recognized because only a single recognition mark is projected on a single switch and recognized. Accordingly, the prior art is problematic in that the size of letters must be reduced or the location of the letters must be changed because the locations of the letters overlap with each other in order to use two types of recognition marks.

### SUMMARY OF THE INVENTION

Embodiments of the present invention include a first printed layer on which a first recognition mark configured to transmit the wavelength of a first light source, but to not transmit the wavelength of a second light source is printed and a second printed layer on which a second recognition mark configured to transmit the wavelength of the second light source, but to not transmit the wavelength of the first light source is printed, thereby enabling switching between the first and the second recognition marks configured to have different colors and overlap with each other on the same surface through a simple configuration.

Furthermore, embodiments of the present invention are directed to implementing printed layers in different colors when mode switches, thereby not requiring a separate indicator for displaying a mode state.

Furthermore, in accordance with embodiments of the present invention, letters can be used without reducing the size of the letters or changing the locations of the letters using printed layers although the locations of the letters overlap with each other up and down.

Furthermore, in accordance with embodiments of the present invention, any recognition mark is not displayed using a background printed layer if a light is not turned on.

In accordance with an aspect of the present invention, there may be provided a multi-print film configured to have a multi-layer structure in which a first recognition mark 110 and a second recognition mark 120 are separately displayed and to include a first printed layer 100 on which the first recognition mark 110 configured to transmit the wavelength of a first light source 5000, but to not transmit the wavelength of a second light source 6000 is printed and a second printed layer 200 on which the second recognition mark 120 configured to transmit the wavelength of the second light source 6000, but to not transmit the wavelength of the first light source 5000 is printed.

Furthermore, the multi-print film may further include a background print layer 300 configured to not transmit the wavelengths of the first light source 5000 and the second light source 6000.

Furthermore, the multi-print film may further include a first limit printed layer 150 disposed between the first printed layer 100 and the second printed layer 200 and configured to transmit a wavelength through a portion where the first light source 5000 overlaps with the second light source 6000.

Furthermore, the multi-print film may further include a second limit printed layer 250 disposed between the background printed layer 300 and the second printed layer 200 and configured to transmit a wavelength through a portion where the first light source 5000 overlaps with the second light source 6000.

Furthermore, the multi-print film may further include a transparent film layer 400 disposed over the first printed layer 100.

Furthermore, the multi-print film may further include a transparent diffusion layer 500 disposed over the transparent film layer 400 and configured to clearly diffuse the first recognition mark 110 or the second recognition mark 120 transmitted by the first light source 5000 or the second light source 6000.

Furthermore, the first light source 5000 may be a blue light source, and the second light source 6000 may be a red light source.

In accordance with another aspect of the present invention, there may be provided a multi-light switch for a vehicle, including a multi-print film 1000 configured to have a multi-layer structure in which the first recognition mark 110 and the second recognition mark 120 are separately displayed and to include the first printed layer 100 on which the first recognition mark 110 that transmits the wavelength of a first light source 5000, but does not transmit the wavelength of a second light source 6000 is printed and the second printed layer 200 on which the second recognition mark 120 that transmits the wavelength of the second light source 6000, but does not transmit the wavelength of the first light source 5000 is printed. When the first light source 5000 is turned on by pressing the button knob 2000 of the light switch, the first recognition mark 110 is displayed, and when the second light source 6000 is turned on by pressing the button knob 2000, the second recognition mark 120 is displayed.

Furthermore, the multi-print film 1000 may further include the background print layer 300 configured to not transmit the wavelengths of the first light source 5000 and the second light source 6000.

Furthermore, the multi-print film 1000 may further include the first limit printed layer 150 disposed between the first printed layer 100 and the second printed layer 200 and configured to transmit a wavelength through a portion where the first light source 5000 overlaps with the second light source 6000.

Furthermore, the multi-print film 1000 may further include the second limit printed layer 250 disposed between the background printed layer 300 and the second printed layer 200 and configured to transmit a wavelength through a portion where the first light source 5000 overlaps with the second light source 6000.

Furthermore, the multi-print film 1000 may further include the transparent film layer 400 disposed over the first printed layer 100.

Furthermore, the multi-print film 1000 may further include the transparent diffusion layer 500 disposed over the transparent film layer 400 and configured to clearly diffuse the first recognition mark 110 or the second recognition mark 120 transmitted by the first light source 5000 or the second light source 6000.

Furthermore, the first light source 5000 may be a blue light source, and the second light source 6000 may be a red light source.

In accordance with embodiments of the present invention, switching can be performed between the first and the second recognition marks configured to have different colors and overlap with each other on the same surface using a simple configuration including the first printed layer on which the first recognition mark configured to transmit the wavelength of the first light source, but to not transmit the wavelength of the second light source is printed and the second printed layer on which the second recognition mark configured to transmit the wavelength of the second light source, but to not transmit the wavelength of the first light source is printed.

Furthermore, in accordance with embodiments of the present invention, a separate indicator for displaying a mode state is not required because printed layers can be implemented in different colors when mode switches.

Furthermore, in accordance with embodiments of the present invention, letters can be used without reducing the size of the letters or changing the locations of the letters using printed layers although the locations of the letters overlap with each other up and down.

Furthermore, in accordance with embodiments of the present invention, any recognition mark may not be displayed using the background printed layer if a light is not turned on.

### BRIEF DESCRIPTION OF THE DRAWINGS

FIG. 1 is a perspective view of a conventional light switch for a vehicle;

FIG. 2 is a cross-sectional view of the conventional light switch for a vehicle;

FIG. 3 illustrates the wavelength regions of light;

FIG. 4 illustrates the wavelength regions and intensities of red, green, and blue that belong to the wavelength regions of light;

FIG. 5 illustrates the three primary colors light;

FIG. 6 is a plan view of a multi-print film in accordance with an embodiment of the present invention;

FIG. 7 is an exploded perspective view of the multi-print film in accordance with an embodiment of the present invention;

FIG. 8 is a cross-sectional view of the multi-print film in accordance with an embodiment of the present invention and illustrates the state when a blue light source is incident;

FIG. 9 is a cross-sectional view of the multi-print film in accordance with an embodiment of the present invention and illustrates the state when a red light source is incident;

FIG. 10 is a perspective view of a multi-light switch for a vehicle in accordance with an embodiment of the present invention;

FIG. 11 is a cross-sectional view of the multi-light switch for a vehicle in accordance with an embodiment of the present invention; and

FIG. 12 illustrates the operation of the multi-light switch for a vehicle in accordance with an embodiment of the present invention.

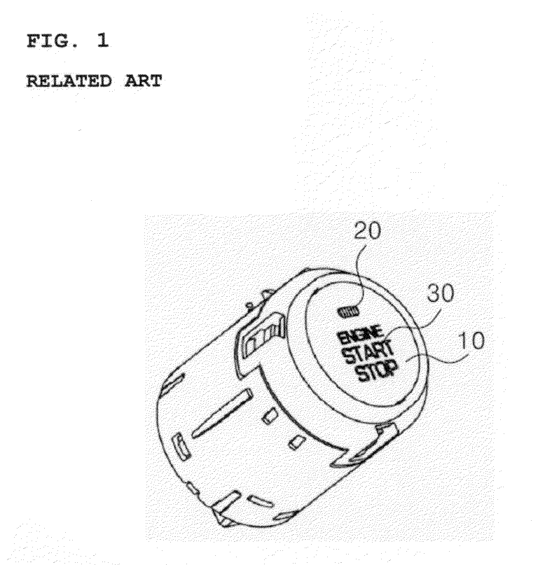

### DETAILED DESCRIPTION

Configurations and operations according to embodiments of the present invention are described in detail with reference to the accompanying drawings.

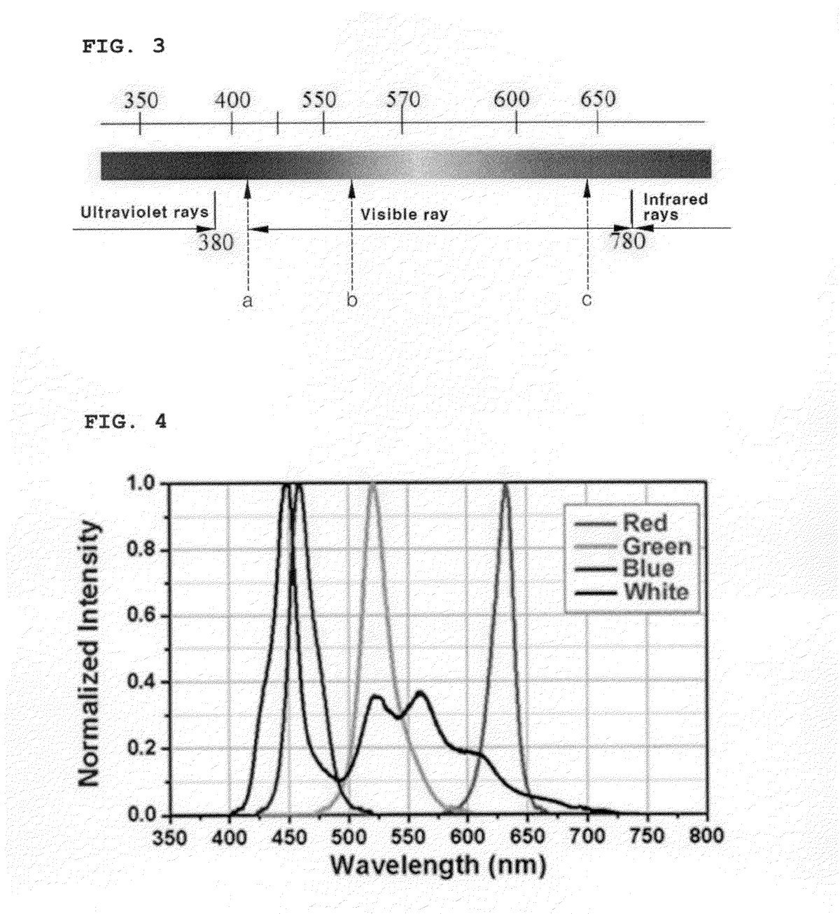

FIG. 3 illustrates the wavelength regions of light, FIG. 4 illustrates the wavelength regions and intensities of red, green, and blue that belong to the wavelength regions of light, and FIG. 5 illustrates the three primary colors of light.

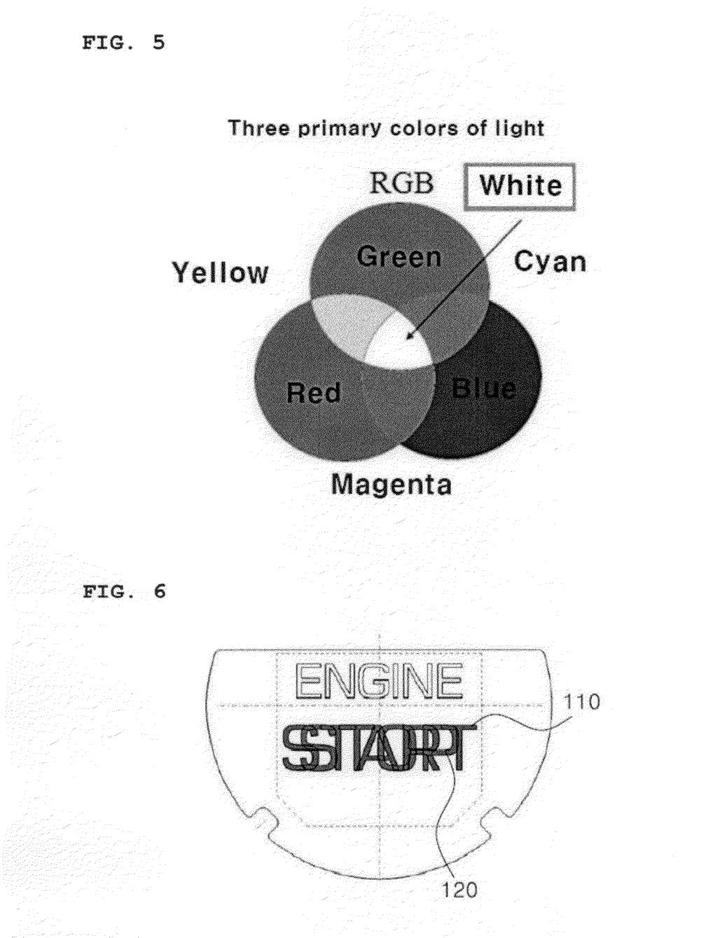

Furthermore, FIG. 6 is a plan view of a multi-print film in accordance with an embodiment of the present invention, and FIG. 7 is an exploded perspective view of the multi-print film in accordance with an embodiment of the present invention.

Referring to FIGS. 3 to 7, the multi-print film in accordance with an embodiment of the present invention has a multi-layer structure in which a first recognition mark 110 and a second recognition mark 120 are separately displayed. The multi-print film includes a first printed layer 100 on which the first recognition mark 110 configured to transmit the wavelength of a first light source 5000, but to not transmit the wavelength of a second light source 6000 is printed and a second printed layer 200 on which the second recognition mark 120 configured to transmit the wavelength of the second light source 6000, but to not transmit the wavelength, of the first light source 5000 is printed.

As illustrated in FIGS. 3 to 5, different colors that are minutely contrasted with each other within a range of a visible ray are not transmitted, but only wavelengths in the same region are transmitted. The printed layers are stacked using a difference between the wavelengths of those colors. Accordingly, multi-mode can be implemented in such a manner that each of the first light source 5000 used as a blue light source and the second light source 6000 used as a red light source transmits the wavelength of corresponding light, but does not transmit the wavelength of another light. In this case, each of the first light source 5000 and the second light source 6000 has only to transmit any one piece of light depending on a difference between the wavelengths. Accordingly, the first light source 5000 and the second light source 6000 are not necessarily limited to the blue light source and the red light source, and vice versa. In some embodiments, the first light source 5000 and the second light source 6000 may be used as a green light source and a red light source.

Furthermore, the multi-print film may further include a background printed layer 300 that does not transmit the wavelengths of the first light source 5000 and the second light source 6000. While the light sources do not operate, the background printed layer 300 prevents the recognition marks printed on the first printed layer 100 and the second printed layer 200 from being displayed.

Furthermore, the multi-print film may further include a first limit printed layer 150 disposed between the first printed layer 100 and the second printed layer 200 and configured to transmit a wavelength through a portion where the first light source 5000 overlaps with the second light source 6000. The multi-print film may further include a second limit printed layer 250 disposed between the background printed layer 300 and the second printed layer 200 and configured to transmit a wavelength through a portion where the first light source 5000 overlaps with the second light source 6000. Each of the first limit printed layer 150 and the second print limit layer 250 is an opaque printed layer and functions to diffuse the concentration of light.

Furthermore, the multi-print film may further include a transparent film layer 400 disposed over the first printed layer 100. The multi-print film may further include a transparent diffusion layer 500 disposed over the transparent film layer 400 and configured to clearly diffuse the first recognition mark 110 or the second recognition mark 120 transmitted by the first light source 5000 or the second light source 6000.

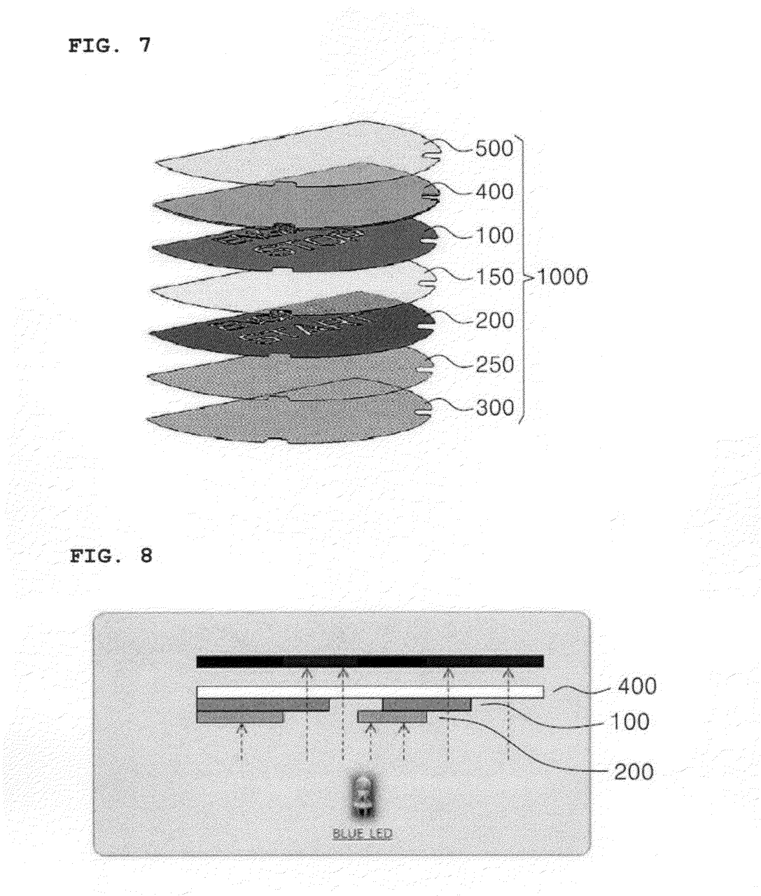

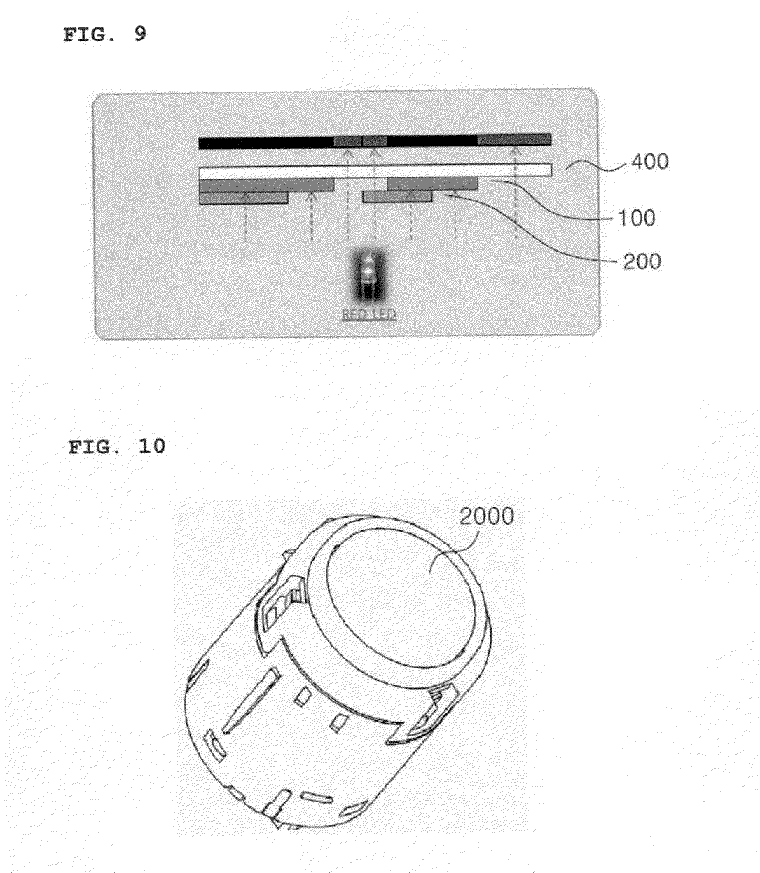

FIG. 8 is a cross-sectional view of the multi-print film in accordance with an embodiment of the present invention and illustrates the state when a blue light source is incident, and FIG. 9 is a cross-sectional view of the multi-print film in accordance with an embodiment of the present invention and illustrates the state when a red light source is incident.

Referring to FIGS. 8 and 9, when the blue light source is turned on as illustrated in FIG. 8, only the first recognition mark 110 of the first printed layer 100 may transmit the wavelength of blue light, and thus the blue light may be recognized. When the red light source is turned on as illustrated in FIG. 9, only the second recognition mark 120 of the second printed layer 200 may transmit the wavelength of red light, and thus the red light may be recognized. If such a multi-print film is used, various types of mode can be represented without a separate indicator.

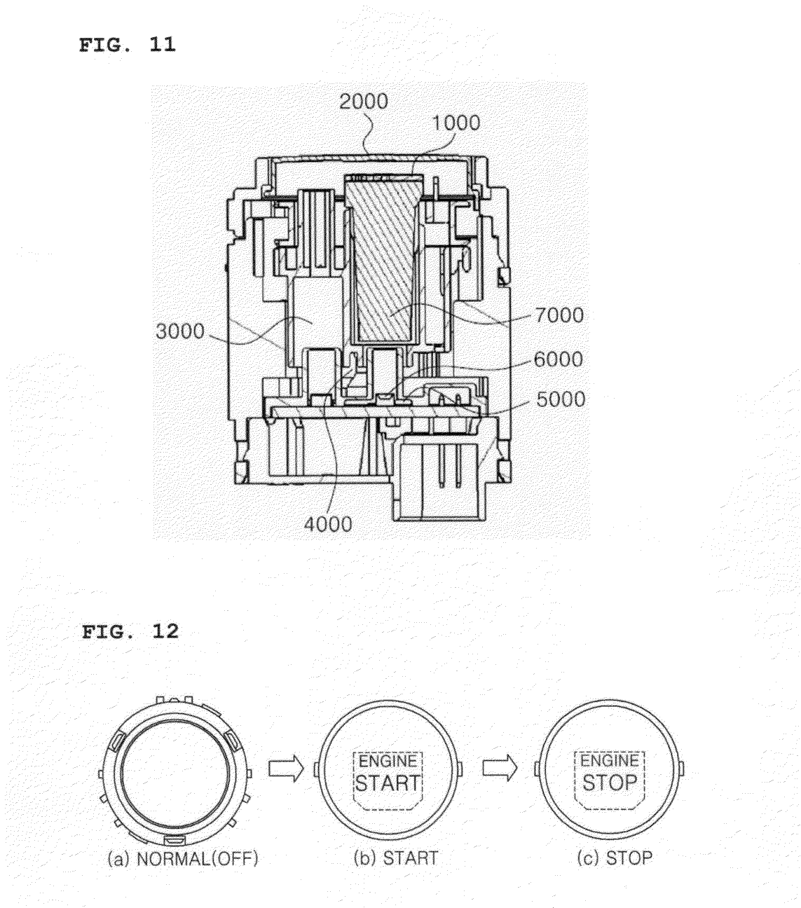

FIG. 10 is a perspective view of a multi-light switch for a vehicle in accordance with an embodiment of the present invention, FIG. 11 is a cross-sectional view of the multi-light switch for a vehicle in accordance with an embodiment of the present invention, and FIG. 12 illustrates the operation of the multi-light switch for a vehicle in accordance with an embodiment of the present invention.

Referring to FIGS. 10 to 12, the multi-light switch for a vehicle in accordance with an embodiment of the present invention includes a multi-print film 1000 configured to have the multi-layer structure in which the first recognition mark 110 and the second recognition mark 120 are separately displayed and to include the first printed layer 100 on which the first recognition mark 110 that transmits the wavelength of a first light source 5000, but does not transmit the wavelength of a second light source 6000 is printed and the second printed layer 200 on which the second recognition mark 120 that transmits the wavelength of the second light source 6000, but does not transmit the wavelength of the first light source 5000 is printed. When the first light source 5000 is turned on by pressing the button knob 2000 of the light switch, the first recognition mark 110 is displayed. When the second light source 6000 is turned on by pressing the button knob 2000, the second recognition mark 120 is displayed.

That is, the multi-light switch for a vehicle in accordance with an embodiment of the present invention includes the multi print film in accordance with an embodiment of the present invention so that the first recognition mark 110 and the second recognition mark 120 can be displayed. As described above, the multi-print film 1000 has the multi-layer structure in which the first recognition mark 110 and the second recognition mark 120 are separately displayed and includes the first printed layer 100 on which the first recognition mark 110 that transmits the wavelength of the first light source 5000, but does not transmit the wavelength of the second light source 6000 is printed and the second printed layer 200 on which the second recognition mark 120 that transmits the wavelength of the second light source 6000, but does not transmit the wavelength of the first light source 5000 is printed. Accordingly, multi-mode can be implemented in such a manner that each of the first light source 5000 used as a blue light source and the second light source 6000 used as a red light source transmits the wavelength of corresponding light, but does not transmit the wavelength of another light. Furthermore, the multi-print film 1000 may further include the background printed layer 300 that does not transmit the wavelengths of the first light source 5000 and the second light source 6000. While the light sources do not operate, the background printed layer 300 prevents the recognition marks printed on the first printed layer 100 and the second printed layer 200 from being displayed.

Furthermore, the multi-print film 1000 may further include the first limit printed layer 150 disposed between the first printed layer 100 and the second printed layer 200 and configured to transmit a wavelength through a portion where the first light source 5000 overlaps with the second light source 6000. The multi-print film may further include the second limit printed layer 250 disposed between the background printed layer 300 and the second printed layer 200 and configured to transmit a wavelength through a portion where the first light source 5000 overlaps with the second light source 6000. Each of the first limit printed layer 150 and the second print limit layer 250 is an opaque printed layer and functions to diffuse the concentration of light.

Furthermore, the multi-print film 1000 may further include the transparent film layer 400 disposed over the first printed layer 100. The multi-print film 1000 may further include the transparent diffusion layer 500 disposed over the transparent film layer 400 and configured to clearly diffuse the first recognition mark 110 or the second recognition mark 120 transmitted by the first light source 5000 or the second light source 6000.

Accordingly, if switching is not performed as illustrated in FIG. 10, nothing is displayed. If switching is performed, a recognition mark printed as the first recognition mark 110 or the second recognition mark 120 is displayed.

The internal structure of the multi-light switch for a vehicle in accordance with an embodiment of the present invention is described below with reference to FIG. 11. A blue light source or a red light source is actuated or not actuated depending on a switching operation so that the first recognition mark 110, the second recognition mark 120, or a background printed on the multi-print film is displayed.

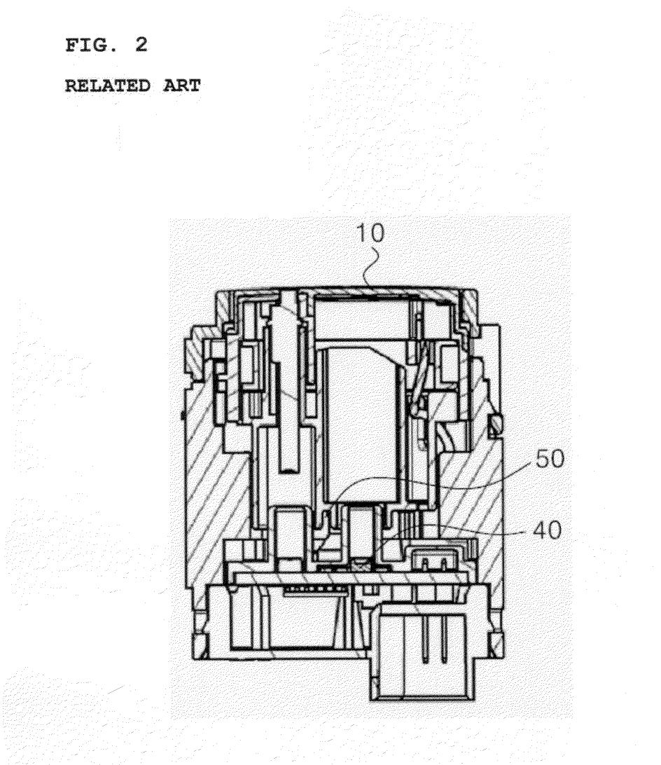

That is, when the switch knob 2000 is pressed, a slider 3000 moves, the contact point 50 (refer to FIG. 2) is switched, and the first light source 5000 or the second light source 6000 is actuated. The wavelength of the first light source 5000 or the second light source 6000 passes through the multi-print film 1000 via a light diffuser 7000. Accordingly, a user can recognize a recognition mark.

From FIG. 12, it may be seen that no recognition mark is displayed when the switch is not actuated, but the blue recognition mark is displayed when the blue light source is activated and the red recognition mark is displayed when the red light source is actuated.

Further, the embodiments discussed have been presented by way of example only and not limitation. Thus, the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A multi-print film, wherein:
the multi-print film has a multi-layer structure in which a first recognition mark (110) and a second recognition mark (120) are separately displayed and comprises:
a first printed layer (100) on which the first recognition mark (110) configured to transmit a wavelength of a first light source (5000), but to not transmit a wavelength of a second light source (6000) is printed; and
a second printed layer (200) on which the second recognition mark (120) configured to transmit the wavelength of the second light source (6000), but to not transmit the wavelength of the first light source (5000) is printed.

2. The multi-print film of claim 1, further comprising a background print layer (300) configured to not transmit the wavelengths of the first light source (5000) and the second light source (6000).

3. The multi-print film of claim 1, further comprising a first limit printed layer (150) disposed between the first printed layer (100) and the second printed layer (200) and configured to transmit a wavelength through a portion where the first light source (5000) overlaps with the second light source (6000).

4. The multi-print film of claim 2, further comprising a second limit printed layer (250) disposed between the background printed layer (300) and the second printed layer (200) and configured to transmit a wavelength through a portion where the first light source (5000) overlaps with the second light source (6000).

5. The multi-print film of claim 1, further comprising a transparent film layer (400) disposed over the first printed layer (100).

6. The multi-print film of claim 5, further comprising a transparent diffusion layer (500) disposed over the transparent film layer (400) and configured to clearly diffuse the first recognition mark (110) or the second recognition mark (120) transmitted by the first light source (5000) or the second light source (6000).

7. The multi-print film of claim 1, wherein:
the first light source (5000) comprise a blue light source, and
the second light source (6000) comprises a red light source.

8. A multi-light switch for a vehicle, comprising:
a multi-print film (1000) configured to have a multi-layer structure in which a first recognition mark (110) and a second recognition mark (120) are separately displayed and to comprise a first printed layer (100) on which the first recognition mark (110) that transmits a wavelength of a first light source (5000), but does not transmit a wavelength of a second light source (6000) is printed and a second printed layer (200) on which the second recognition mark (120) that transmits the wavelength of the second light source (6000), but does not transmit the wavelength of the first light source (5000) is printed,
wherein when the first light source (5000) is turned on by pressing a button knob (2000) of the light switch, the first recognition mark (110) is displayed, and when the second light source (6000) is turned on by pressing the button knob (2000), the second recognition mark (120) is displayed.

9. The multi-light switch of claim 8, wherein the multi-print film (1000) further comprises a background print layer (300) configured to not transmit the wavelengths of the first light source (5000) and the second light source (6000).

10. The multi-light switch of claim 8, wherein the multi-print film (1000) further comprises a first limit Printed layer (150) disposed between the first printed layer (100) and the second printed layer (200) and configured to transmit a wavelength through a portion where the first light source (5000) overlaps with the second light source (6000).

11. The multi-light switch of claim 9, wherein the multi-print film (1000) further comprises a second limit printed layer (250) disposed between the background printed layer (300) and the second printed layer (200) and configured to transmit a wavelength through a portion where the first light source (5000) overlaps with the second light source (6000).

12. The multi-light switch of claim 8, wherein the multi-print film (1000) further comprises a transparent film layer (400) disposed over the first printed layer (100).

13. The multi-light switch of claim 12, wherein the multi-print film (1000) further comprises a transparent diffusion layer (500) disposed over the transparent film layer (400) and configured to clearly diffuse the first recognition mark (110) or the second recognition mark (120) transmitted by the first light source (5000) or the second light source (6000).

14. The multi-light switch of claim 8, wherein:
the first light source (5000) comprises a blue light source, and
the second light source (6000) comprises a red light source.
